(19) United States
(12) Patent Application Publication
(10) Pub. No.: US 2019/0353061 A1
(43) Pub. Date: Nov. 21, 2019

(54) CONTROL VALVE FOR A CAMSHAFT ADJUSTER

(71) Applicant: SCHAEFFLER TECHNOLOGIES AG & CO. KG, Herzogenaurach (DE)

(72) Inventors: David KOEHLER, Egloffstein (DE); Stefan KRAMER, Hoechstadt/Aisch (DE)

(73) Assignee: SCHAEFFLER TECHNOLOGIES AG & CO. KG, Herzogenaurach (DE)

(21) Appl. No.: 16/526,249

(22) Filed: Jul. 30, 2019

Related U.S. Application Data
(63) Continuation of application No. 15/759,392, filed on Mar. 12, 2018.

(30) Foreign Application Priority Data
Sep. 21, 2015 (DE) 102015218072.7

(51) Int. Cl. F01L 1/344; F16K 11/07

(52) U.S. Cl. CPC F01L 1/3442; F16K 11/0716; F01L 2001/34426; F01L 2001/34423; F01L 2001/34446; F01L 2001/34433

(57) ABSTRACT

A control valve for a camshaft adjuster for an engine is provided. The control valve includes a valve sleeve having one or more inlet openings, two supply openings, and an outlet opening, and a control piston guided in the valve sleeve. The piston, together with the valve sleeve and control edges arranged on the control piston, form three annular ducts. A fluid-conducting connection between an inlet opening and a supply opening can be controlled via a first annular channel. A fluid-conducting connection between the inlet opening and another supply opening can be controlled via a second annular channel. The first annular channel and the second annular channels may enclose a central annular channel, via which a fluid-conducting connection between the supply opening and the outlet opening, as well as between the another supply opening and the outlet opening, can be controlled.

### CROSS-REFERENCE TO RELATED APPLICATIONS

This application is a continuation of U.S. application Ser. No. 15/759,392 filed Mar. 12, 2018, which is a U.S. National Phase of PCT/DE2016/200409 filed Sep. 1, 2016, which claims priority to DE 102015218072.7 filed Sep. 21, 2015, the entire disclosures of which are incorporated by reference herein.

### TECHNICAL FIELD

This disclosure is directed to the field of proportional directional valves, which can be used as control valves, especially for controlling camshaft adjusters. Camshaft adjusters are used to control the operation of a combustion engine by specifically affecting the charge exchange: an adjustment of the phase position of the camshaft changes its position in relation to the phase position of the crankshaft; as a result, it is possible to move the opening and closing times of the gas exchange valves to an earlier or later point in time of the continuous cycle. Control valves have multiple switching positions, by adjusting the course of the pressure medium path between inlet and outlet, and depending on the switching position, the pressure medium flow exerts a force on the camshaft adjuster, causing an adjustment to a certain position.

### BACKGROUND

DE 10 2012 201 567 A1 shows a control valve for a camshaft adjuster having a control valve housing designed in the form of a central screw, which has a screw shaft, a tubular section and a screw head, as well as a hollow cylindrical control piston that can be moved inside a valve housing. Inside the piston cavity there is a hydraulically unlockable check valve releasing a first pressure medium line in flow direction, which check valve has a closing section with a sealing surface, and the inlet opening can be closed in reverse direction. Via the inlet connection and a channel formed axially on the valve housing, the pressure medium flows into one of the supply ports A or B, which supply the working chambers of a hydraulic camshaft adjuster with pressure medium.

The discharge of the pressure medium from the supplied working chambers of the camshaft adjuster is initially also carried out via the supply ports A and B into a respective first and second control groove formed on the control piston. The discharge is carried out either directly via the first control groove or indirectly via the second control groove, the piston cavity and the first control groove. With the pressure medium discharged via the outlet connection, a volume accumulator is fed, which is integrated in the camshaft adjuster.

It is the objective of this disclosure to improve a control valve and a camshaft adjuster with such a control valve.

### SUMMARY

Accordingly, this disclosure provides a control valve for a camshaft adjuster, in which control valve includes a valve sleeve having one or more inlet openings, two supply openings and an outlet opening and a control piston guided in the valve sleeve, and the piston, together with the valve sleeve and control edges arranged on the control piston, forms three annular ducts. A fluid-conducting connection between an inlet opening P and a supply opening A can be controlled via an annular channel A; a fluid-conducting connection between an inlet opening P or a further inlet opening, which is axially spaced from the inlet opening P, and a supply opening B can be controlled via an annular channel B. The annular channel A and the annular channel B enclose a central annular channel, via which a fluid-conducting connection between the supply opening A and the outlet opening C, as well as between the supply opening B and the outlet opening C, can be controlled.

Outlet openings provide a controllable connection between the supply openings and the surrounding area of the control valve. In this way, the pressure medium is returned to the hydraulic fluid circuit of the combustion engine. Usually, the discharge of the pressure medium is carried out via separate outlet openings of the control valve, each of which is attached to one of the supply openings. Alternatively, the pressure medium flowing from multiple supply openings can be discharged via a mutual outlet opening. However, the pressure medium path described requires in well-known manner a mutual pressure medium line through the piston cavity, which therefore can no longer be used for other purposes.

According to an embodiment, a mutual outlet opening can be achieved without having to guide the discharging pressure medium via the piston cavity: the discharge can be carried out directly via a mutual, central annular channel via the arrangement of the outlet opening between the supply openings. In an embodiment, it is possible to produce a direct connection between the supply openings A and B to the outlet opening C. Thus, the discharge of the pressure medium is only subject to minor pressure losses.

Outlet opening, inlet opening(s) and supply openings are respectively arranged at an axial position. At each respective axial position, multiple openings can be arranged along the circumference.

In an embodiment, the control piston comprises a piston cavity, wherein the central annular channel can be directly connected with the outlet opening C, the annular channel A can be directly connected with the supply opening A, and the annular channel B can be directly connected with the supply opening B. One of the annular channels A or B can be directly connected with the inlet opening P, wherein the other one of the annular channels A or B can be indirectly connected via the cavity of the control piston with the inlet opening P (indirect connection). Via the proposed embodiment, it is possible to implement a control valve, which shows advantages especially with a view to the axial space requirements.

In an embodiment, the indirect connection occurs via an annular supply channel formed in the piston cavity. Said annular supply channel is indirectly connected via piston openings A and B with the annular channel A and the annular channel B. In this way, a connection can be produced in a constructively simple manner between the annular channels A and B, which are separated by the central annular channel.

In an embodiment, the annular supply channel is formed between the inside surface of the control piston and the outside surface of a tubular piston insert. The proposed further development allows for a cost-effective production of the control piston.

In an embodiment, the piston insert basically seals the annular supply channel toward the surrounding area. At the same time, a space formed between valve sleeve and control piston is connected with the surrounding area via a channel formed in the piston insert. For example, in an embodiment, the channel allows for ventilation of the space, which is enclosed by the floor of the control piston and the inside surface of the valve sleeve. In addition, it is possible that pressure medium, which has entered said space due to leakage, is released to the surrounding area.

In a further embodiment, the valve sleeve is designed in the form of a central screw. In this way, it is possible to produce a connection between the control valve and a camshaft as receiving component. In addition, the control valve can also be used to attach further components to the camshaft, for example, the rotor of a hydraulic camshaft adjuster.

In an embodiment, the valve sleeve comprises a plastic injection molding. Via the plastic injection molding, a guide for the pressure medium can be implemented, for example, by providing longitudinal channels between valve sleeve and a component receiving the valve sleeve. Therefore, the axial position of inlet openings, outlet openings and supply openings does not have to correspond to the axial position of openings, which give access to further pressure medium lines on the receiving component.

In a further embodiment, the valve sleeve is arranged in a central screw. At the same time, the plastic-coated valve sleeve is accepted by the central screw. Preferably, the inlet opening is connected via an axial channel formed in the plastic injection molding with an inlet connection formed on the central screw. As a result, pressure medium can be supplied via a camshaft bearing and the camshaft, in that pressure medium enters the central screw in axial or radial manner via the inlet connection, passes in axial direction through a check valve and then flows via the axial channel and via the inlet opening into the annular channel. In addition, a design in the form of a central screw shows the above-mentioned advantages.

The objective is also achieved by a camshaft adjuster having a stator, a rotor and a control valve in one of the embodiments described above. The control valve is designed in the form of a central valve, wherein the supply opening A is connected with a working chamber A formed between stator and rotor, and the supply opening B is connected with a working chamber B formed between stator and rotor. The outlet opening C is connected with a volume accumulator, wherein the volume accumulator can be connected with working chamber A, working chamber B and via an outlet connection with the surrounding area.

The main components of a camshaft adjuster in the design of a vane cell adjuster involves a stator and a rotor. The Stator can be connected in torque-proof manner with a drive wheel and driven via a traction drive by the crankshaft. The rotor forms the drive element. Rotor and stator include a pressure chamber, which is divided via a wing formed on the rotor in working chambers A and B. Working chamber A and B can be connected with the supply ports A and B of a control valve: pressurization via a pressure medium results in a relative rotation of the rotor in relation to the stator.

A volume accumulator, which is supplied via the outlet connection C, can be arranged in the camshaft adjuster or in an area between camshaft adjuster and control valve. If low pressure occurs in one of the working chambers, pressure medium can flow from the volume accumulator via check valves into the working chamber and offset the low pressure. The volume accumulator can have a further outlet connection to a reservoir (tank).

### BRIEF DESCRIPTION OF THE DRAWINGS

Various embodiments are now described in more detail with reference to the drawings. Functionally equivalent elements of the embodiments described are marked with the same reference signs.

FIG. 1 shows a longitudinal section of the control valve of the embodiment depicted;

FIG. 2 shows the control valve depicted in FIG. 1 in a second switching position;

FIG. 3 shows in an exemplary manner a camshaft adjuster having a volume accumulator and the control valve depicted in FIG. 1.

### DETAILED DESCRIPTION OF THE DRAWINGS

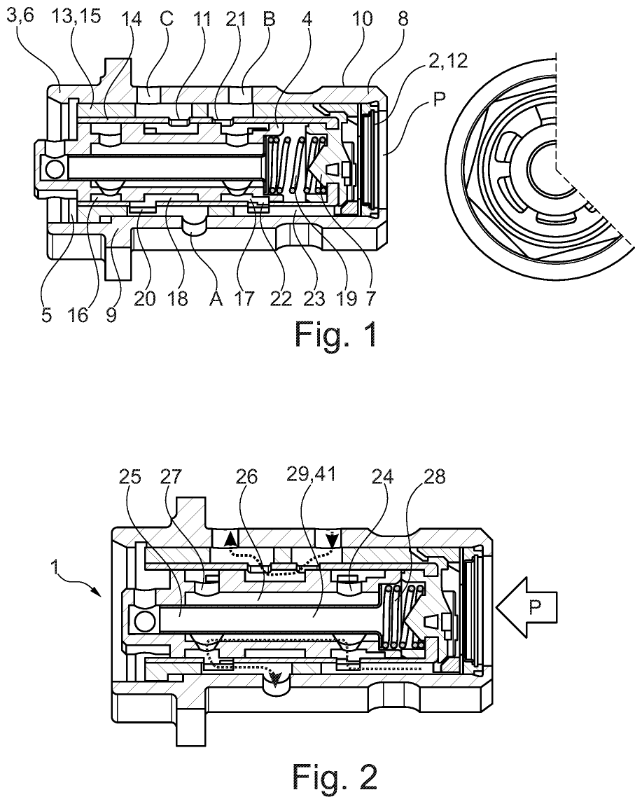

FIG. 1 shows a longitudinal section of an exemplary embodiment of a control valve 1. The control valve comprises a central screw as valve housing 3 and a hollow cylindrical control piston 4, which can be axially moved in a respective hollow space of the valve housing 3. The adjustment range of the control piston 4 is axially limited by a retaining ring 5 at the first end 6 and a closing element 7 at the second end 8. The valve housing 3 can be received by a hollow space of a camshaft and be used for controlling a camshaft adjuster (see FIG. 4). Together with an outer thread 10, a flange 9 serves the purpose of connecting the control valve 1 and the camshaft. On its outer circumference, the valve housing 3 has three connections: the connections form the supply port A, the further supply port B and the outlet connection C. An inlet connection P is located at the second end 8 of the valve housing. A filter 12 and a check valve 2 are arranged around the opening, which forms the inlet connection P.

The control piston 4 is guided inside a valve sleeve 13. The valve sleeve 13 comprises an internal component 14 and an external component 15. The internal component 14 is produced from a metallic material and is surrounded by an external plastic component. 15. Both components are designed in the form of a sleeve or hollow cylinder. The external sleeve-shaped component 15 is produced as an injection-molded part and the internal sleeve-shaped components 14 as an insert, which is overmolded during the injection molding process of the external component.

On its outside surface, the control piston 4 has four sections with expanded diameter, which include three sections with a reduced diameter. Together with the inside surface of the valve sleeve 13, said sections form an annular channel A 16, an annular channel B 17 and a central annular channel 18. To control a camshaft adjuster, the control piston 4 can assume two switching positions, which are marked by the actual course of possible pressure medium paths.

A switching position is implemented via a setting device (not shown), which usually involves an electromagnetic actuator. A push rod connected to an anchor of the electric magnet is brought in contact with an actuation surface at the front end of the control piston 4. As a result, the force exerted on the anchor is transferred via the push rod to the control piston 4, thus causing an axial movement against the force of a spring 19: the annular channel A 16 can be moved into the axial position of the supply opening A 20. Therefore, the annular channel B 17 can be brought into the axial positions of the supply opening B 21 and the inlet opening P 22. The central annular channel 18 can be brought into the axial positions of the supply opening A 20 and the supply opening B 21.

In this way, the first switching position shown in FIG. 1 can be set. The setting device is not energized, which leaves the control piston 4 in a non-actuated position. In the first switching position, a pressure medium path is achieved between the inlet connection P and the supply port B. An additional pressure medium path is produced between the supply port A and the output connection C.

FIG. 2 shows the control valve in its second switching position. The setting device is energized and therefore the control piston is in an actuated position. In the second switching position, a pressure medium path 4 is produced between the supply port B and the outlet connection C. A further pressure medium path is produced between the inlet connection B and the supply port A: the pressure medium flows via the inlet connection P into the control valve 1 and flows along an axial channel 23 in the inlet opening P, which is overmolded with plastic, into the inlet opening P. From there, the pressure medium path runs via the piston opening B 24 into the annular supply channel 26 formed via a piston insert 25 in the piston cavity. The piston opening A 27, which adjoins the annular supply channel 26, opens the way into the annular channel A 16, and which in the second switching position a connection is available to the supply opening A 20 and to the supply port A.

Therefore, the annular supply channel 26 is formed between the inside surface of the control piston 4 and the outside surface of a tubular piston insert 25. In this way, it is possible to produce an indirect connection via an annular supply channel 26 formed in the piston cavity 28. The annular supply channel 26 is directly connected via the piston openings A and B 27, 24 with the annular channel A 16 and the annular channel B 17. In addition, the piston insert 27 basically seals the annular supply channel 26 toward the surrounding area, wherein a space 28 formed between valve sleeve and control piston is connected with the surrounding area via a channel 29 formed in the piston insert 27.

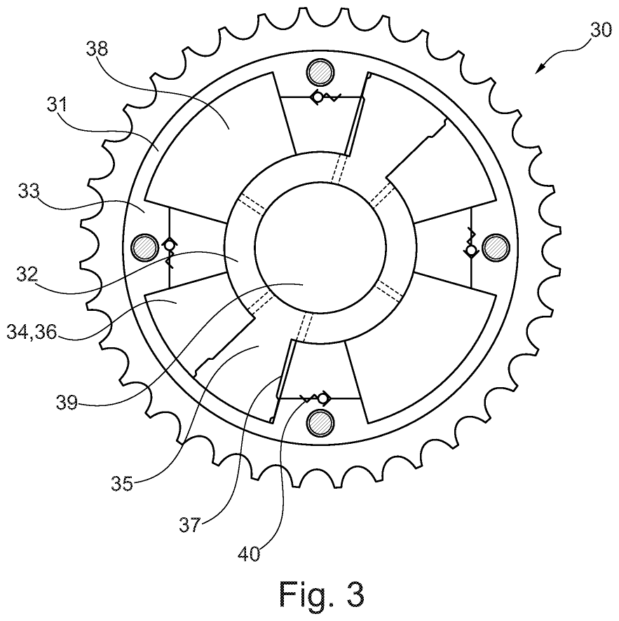

FIG. 3 shows a hydraulic camshaft adjuster 30 having a stator 31 and a rotor 32. It displays two pressure chambers 34 enclosed by stator and rotor and separated from one another by chamber walls 33. Via a wing 35, said pressure chambers 34 are respectively divided into two working chambers A and B, or 36, 37, which are hydraulically working against each other. The hydraulic camshaft adjuster also has a volume accumulator 38. In the center, a receptacle 39 for a control valve of the embodiment described above is arranged. Each of the working chambers A 36 can be brought into fluid-conducting connection with supply port A, and each of the working chambers B 37 can be brought in fluid-conducting connection with the supply port B 29. The volume accumulator 38 can be brought in fluid-conducting connection with the output connection C.

In addition, the volume accumulator 38 can be brought in fluid-conducting connection with the working chamber A 36 and the working chamber B 37. For this purpose, hydraulic channels are located in the chamber walls 33 of the stator. Check valves are used to prevent pressure medium from flowing from one of the working chambers 36, 37 to the volume accumulator. The volume accumulator 38 also has an outlet, which has the purpose of supplying hydraulic fluid to a reservoir (tank).

### LIST OF REFERENCE SIGNS

1 control valve
2 check valve
3 central screw, valve housing
4 control piston
5 retaining ring
6 first end
7 closing element
8 second end
9 flange
10 outer thread
11 outlet opening C
12 filter
13 valve sleeve
14 internal component
15 external component, plastic injection molding
16 annular channel A
17 annular channel B
18 central annular channel
19 spring
20 supply opening A
21 supply opening B
22 inlet opening P
23 axial channel
24 piston opening B
25 piston insert
26 annular supply channel
27 piston opening A
28 space formed between valve sleeve and control piston
29 channel
30 camshaft adjuster
31 stator
32 rotor
33 chamber wall
34 pressure chamber
35 wing
36 working chamber A
37 working chamber B
38 volume accumulator
39 receptacle
40 check valve
41 piston cavity
A supply port A
B supply port B
P inlet connection P
C outlet connection C
T outlet connection T

What is claimed is:

1. A camshaft adjuster comprising:
a stator;
a rotor;
a first working chamber formed between the stator and the rotor;
a second working chamber formed between the stator and the rotor; and
a control valve having:
a valve sleeve having one or more inlet openings, a first supply opening, a second supply opening, and an outlet opening;
a control piston guided in the valve sleeve, wherein the piston and the valve sleeve form a first annular channel, a second annular channel, and a central annular channel;
wherein:
the first supply opening is connected with the first working chamber,
the second supply opening is connected with the second working chamber, and
the outlet opening is connected with a volume accumulator, wherein the volume accumulator is configured to be connected to the first working chamber and the second working chamber.

2. The camshaft adjuster of claim 1, wherein:
a first fluid-conducting connection between one of the one or more inlet openings and the first supply opening can be controlled via the first annular channel;
a second fluid-conducting connection between one of the one or more inlet openings and a second supply opening can be controlled via a second annular channel; and
the first annular channel and the second annular channel enclose the central annular channel, via which a fluid-conducting connection between the supply opening and the outlet opening, as well as between the supply opening and the outlet opening, can be controlled.

3. The camshaft adjuster of claim 1, wherein the volume accumulator is further configured to be connected to an outlet connection.

4. The camshaft adjuster of claim 1, wherein the control piston comprises a piston cavity, wherein the central annular channel can be directly connected with the outlet opening, the first annular channel can be directly connected with the first supply opening, and the second annular channel can be directly connected with the second supply opening, wherein one of the annular channels can be directly connected with the inlet opening, and wherein the other one of the annular channels can be indirectly connected via the piston cavity with the inlet opening.

5. The camshaft adjuster of claim 4, wherein the indirect connection is carried out via an annular supply channel formed in the piston cavity, which the annular supply channel is directly connected with the first annular channel and the second annular channel, via a first piston opening and a second piston opening.

6. The camshaft adjuster of claim 5, wherein the annular supply channel is formed between an inside surface of the control piston and an outside surface of a tubular piston insert.

7. The camshaft adjuster of claim 6, wherein the piston insert seals the annular supply channel toward a surrounding area, wherein a space formed between the valve sleeve and the control piston is connected via a channel formed in the piston insert with the surrounding area.

8. The camshaft adjuster of claim 1, wherein the valve sleeve is designed in the form of a central screw.

9. The camshaft adjuster of claim 1, wherein the valve sleeve has a plastic injection molding.

10. The camshaft adjuster of claim 9, wherein the valve sleeve is arranged in a central screw.

11. The camshaft adjuster of claim 10, wherein the inlet opening is connected via an axial channel formed in the plastic injection molding with an inlet connection formed on the central screw.

12. A control valve configured for a camshaft adjuster having a stator and a rotor that form a first working chamber and a second working chamber, the control valve comprising:
a valve sleeve having one or more inlet openings, a first supply opening, a second supply opening, and an outlet opening;
a control piston guided in the valve sleeve, wherein the piston and the valve sleeve form a first annular channel, a second annular channel, and a central annular channel;
wherein:
the first supply opening is configured to be connected with the first working chamber,
the second supply opening is configured to be connected with the second working chamber, and
the outlet opening is configured to be connected with a volume accumulator, wherein the volume accumulator is configured to be connected to the first working chamber and the second working chamber.

13. The control valve of claim 12, wherein:
a first fluid-conducting connection between one of the one or more inlet openings and the first supply opening can be controlled via the first annular channel;
a second fluid-conducting connection between one of the one or more inlet openings and a second supply opening can be controlled via a second annular channel; and
the first annular channel and the second annular channel enclose the central annular channel, via which a fluid-conducting connection between the supply opening and the outlet opening, as well as between the supply opening and the outlet opening, can be controlled.

14. The control valve of claim 12, wherein the volume accumulator is further configured to be connected to an outlet connection.

15. The control valve of claim 12, wherein the control piston comprises a piston cavity, wherein the central annular channel can be directly connected with the outlet opening, the first annular channel can be directly connected with the first supply opening, and the second annular channel can be directly connected with the second supply opening, wherein one of the annular channels can be directly connected with the inlet opening, and wherein the other one of the annular channels can be indirectly connected via the piston cavity with the inlet opening.

16. The control valve of claim 15, wherein the indirect connection is carried out via an annular supply channel formed in the piston cavity, which the annular supply channel is directly connected with the first annular channel and the second annular channel, via a first piston opening and a second piston opening.

17. The control valve of claim 16, wherein the annular supply channel is formed between an inside surface of the control piston and an outside surface of a tubular piston insert.

18. The control valve of claim 17, wherein the piston insert seals the annular supply channel toward a surrounding area, wherein a space formed between the valve sleeve and the control piston is connected via a channel formed in the piston insert with the surrounding area.

19. The control valve of claim 12, wherein the valve sleeve is designed in the form of a central screw.

20. The control valve of claim 12, wherein the valve sleeve has a plastic injection molding.
